(19) United States
(12) Patent Application Publication
(10) Pub. No.: US 2006/0242070 A1
(43) Pub. Date: Oct. 26, 2006

(54) Hard disk recording and playback device

(75) Inventor: Kentaro Takagi, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/408,975

(22) Filed: Apr. 24, 2006

(30) Foreign Application Priority Data
Apr. 25, 2005 (JP) P2005-126124

(51) Int. Cl. G06Q 99/00

(52) U.S. Cl. 705/50

(57) ABSTRACT

A hard disk recording and playback device includes: a control unit that performs a control such that an electronic program guide is displayed on a display device, the electronic program guide including a series distinction item, an ON/OFF item for turning on/off a series distinction function, and a number information item indicating that each series corresponds to which number of the episode in the series, and after a corresponding series is recorded in a state in which the ON of the ON/OFF item is selected so as to turn on the series distinction function and number information, which indicates that the corresponding series corresponds to which number of the episode in the series, is input to the number information item, the corresponding series is stored in a folder to which a title of the episode is applied as a name thereof.

### BACKGROUND OF THE INVENTION

1. Field of the Invention

The present invention relates to a hard disk recording and playback device that performs a recording/playback of information with respect to a hard disk, and in particular, a hard disk recording and playback device having a distinction function with respect to a series program.

2. Description of the Related Art

In recent years, a hard disk capable of recording a large amount of information is widely used so as to record a television program or the like. The recording/playback of information with respect to the hard disk is generally performed by a hard disk recording and playback device called as a hard disk recorder. When a user plays back a desired television program after recording various television programs on the hard disk, many program titles are displayed on a playback menu screen of a display device of a television receiver, and accordingly, it is necessary for the user to select one of the program titles corresponding to the desired program.

In addition, as broadcasted television programs, there are many series programs that are broadcasted every predetermined period of time, for example, in a daily or weekly basis. In this case, a user can sequentially record the series programs on the hard disk recording and playback device by performing series recording reservation with respect to the hard disk recording and playback device. However, in order to play back the programs recorded by the series recording reservation, it has been requested to display a list of the recorded programs on the playback menu screen, to search for the desired series program among the recorded programs, and then to select and playback the desired series program.

In this case, even though it is possible to sequentially record the series programs by means of the series recording reservation, the program menu is displayed in the recording order; accordingly, for example, assuming that episode #1 of a series A, episode #1 of a series B, and episode #2 of the series A are displayed, if a user desires to watch the episode #1 and episode #2 of the series A, the user had to individually select the episode #1 and the episode #2 of the series A which are not consecutively displayed on the playback menu screen, and as a result, a selection operation has been troublesome (see Japanese Utility Model No. 3088367, JP-A-2001-197411 and JP-A-2002-84481).

### SUMMARY OF THE INVENTION

Therefore, in a conventional hard disk recording and playback device, in order to avoid the selection operation described above, a user decides a storage folder for storing a file recorded on the basis of a genre and applies an episode title as a name of the folder or stores the same series in the same folder at the time of genre classification or recording reservation. However, in the conventional hard disk recording and playback device, a lot of key operations are needed, which causes the classification work to be troublesome.

Further, in a conventional technique disclosed in Japanese Utility Model No. 308867, when a recording reservation with respect to series picture data is selected, a control unit gives the picture data a series number and a series sequence number indicating that the broadcast picture data corresponds to which number of the episode in the series and then creates series information related to contents information of the recording reserved picture data so as to store the series number and the series sequence number in a second memory unit. In addition, when the series picture data is to be played back, the control unit reads out the series information stored in the second memory unit and displays the read series information on a monitor, and then when only a series number that a user desires to play back is selected from the displayed series information, the control unit plays back picture data of a corresponding series number in the order of a series sequence number through an HDD on the basis of contents information related to a series sequence number included in the series number.

In the conventional technique, the series information is stored in a storage medium for the purpose of the management of picture data. However, in the conventional technique, an explanation on a folder is not made, and besides, there is no explanation on the classification work described above, that is, a work in which a user decides a storage folder for storing a file recorded on the basis of a genre and applying an episode title as a name of the folder or stores the same series in the same folder at the time of genre classification or recording reservation.

Furthermore, in a conventional technique disclosed in JP-A-2001-197411, it is determined whether or not a recording reserved program is a series program, and when it is determined that the recording reserved program is the series program, it is determined whether or not the series program is recording-reserved with respect to the same recording medium as a recording medium on which an immediately previous episode of the series program is recorded. Then, a result of the determination is informed to a user. As such, in the conventional technique, series programs are recorded on the same recording medium. However, even in the conventional technique, an explanation on a folder is not made, and besides, there is no explanation on the classification work described above, that is, a work in which a user decides a storage folder for storing a file recorded on the basis of a genre and applying an episode title as a name of the folder or stores the same series in the same folder at the time of genre classification or recording reservation.

In addition, in a conventional technique disclosed in JP-A-2002-84481, when a series broadcasting program, which includes first to n-th episodes and is broadcasted in a monthly, weekly, or daily basis, is timer-recorded, a control unit that controls a fixed disk driving unit is included and an i-th episode of the series program is recorded on the basis of a reservation mode. In the conventional technique, a file for the series broadcasting program is managed by using a program file. However, even in the conventional technique, an explanation on a folder is not made, and besides, there is no explanation on the classification work described above, that is, a work in which a user decides a storage folder for storing a file recorded on the basis of a genre and applying an episode title as a name of the folder or stores the same series in the same folder at the time of genre classification or recording reservation.

In order to solve the above-mentioned problems, it is an object of the invention to provide a hard disk recorder having a function of automatically classifying files, which correspond to the same series program, into the same folder. That is, a conventional hard disk recording and playback device has a function of classifying files in which television programs are recorded on the basis of the genre; however, only with the function of classifying the files on the basis of the genre, various programs are stored in the same folder corresponding to the same genre such as “drama”, which causes the files to be disordered. Therefore, it is an object of the invention to provide a hard disk recording and playback device capable of allocating a new file with respect to a program, such as a series, in which a number of episodes are sequentially broadcasted.

According to an aspect of the invention, a hard disk recording and playback includes a control unit having an electronic program guide display unit that displays an electronic program guide on a display device, the electronic program guide including a date item for displaying a broadcasting date of a television program, a time item for displaying a broadcasting time of the television program, a channel item for displaying a channel of the television program, an episode title item for displaying an episode title, a genre item for displaying a genre of the television program, a series distinction item, an ON/OFF item for turning on/off a series distinction function, and a number information item indicating that each series corresponds to which number of the episode in the series; a file existence determination unit that determines whether or not a file made by using the series distinction function exists, after a corresponding series is recorded in a state in which the ON of the ON/OFF item displayed on the electronic program guide is selected so as to turn on the series distinction function and number information, which indicates that the corresponding series corresponds to which number of the episode in the series, is input to the number information item or after a corresponding television program is recorded in a state in which the series distinction function is turned off; a genre classification unit that classifies the television program on the basis of a genre when it is determined that the file does not exist; an episode determination unit that determines whether or not the corresponding episode is an episode previously set by using the series distinction function when it is determined that the file exist; a first number information item update unit that updates number information of the number information item, which indicates that the corresponding episode corresponds to which number of the episode in the series, stored in a memory by incrementing the number information of the number information item when it is determined that the corresponding episode is an episode previously set by using the series distinction function; a first folder storage unit that stores a corresponding episode file in a folder to which a title of the episode based on the updated number information, which indicates that the corresponding episode corresponds to which number of the episode in the series, is applied as a name thereof; a second number information item update unit that updates the number information of the number information item, which indicates that the corresponding episode corresponds to which number of the episode in the series, stored in the memory by incrementing the number information of the number information item when the episode determination unit determines that the corresponding episode is not an episode previously set by using the series distinction function; a folder existence determination unit that determines whether or not a folder whose name is the same as the episode title exists after the number information, which indicates that the corresponding episode corresponds to which number of the episode in the series, has been updated by the second number information item update unit; a second folder storage unit that, when it is determined that the folder whose name is the same as the episode title exist, stores the corresponding episode file in the folder whose name is the same as the episode title by adding the number information, which indicates that the episode corresponds to which number of the episode in the series, without creating a new folder; a third folder storage unit that, when it is determined that the folder whose name is the same as the episode title does not exist, creates a new folder and applies the number information, which indicates that the episode corresponds to which number of the episode in the series, to the new folder so as to store the corresponding episode file in the newly created folder; and a reservation recording start unit that, in the case of a weekly reservation recording, starts recording the corresponding program on the basis of information indicating the same day of the week, the same channel, and the same broadcasting time that are stored beforehand in the memory at the time of reservation.

In the configuration described above, it is determined by the file existence determination unit whether or not a file made by using the series distinction function exists. If it is determined that the file made by using the series distinction function does not exist, the television program is classified on the basis of a genre by means of the genre classification unit, and if it is determined that the file made by using the series distinction function exists, it is determined by the episode determination unit whether or not the corresponding episode is an episode previously set by using the series distinction function.

If it is determined that the corresponding episode is an episode previously set by using the series distinction function, the number information of the number information item is incremented to be updated by means of the first number information item update unit. Then, the corresponding episode file is stored, by the first folder storage unit, in a folder to which a title of the episode based on the updated number information, which indicates that the corresponding episode corresponds to which number of the episode in the series, is applied as a name thereof.

On the other hand, if it is determined that the corresponding episode is not an episode previously set by using the series distinction function, the number information of the number information item is incremented to be updated by means of the second number information item update unit. After the number information, which indicates that the corresponding episode corresponds to which number of the episode in the series, has been updated by the second number information item update unit, it is determined by the folder existence determination unit whether or not a folder whose name is the same as the episode title exists.

If it is determined that the folder whose name is the same as the episode title exist, the corresponding episode file is stored, by the second folder storage unit, in the folder whose name is the same as the episode title by adding the number information, which indicates that the episode corresponds to which number of the episode in the series, without creating a new folder. If it is determined that the folder whose name is the same as the episode title does not exist, a new folder is created and the number information, which indicates that the episode corresponds to which number of the episode in the series, is applied to the new folder so as to store the corresponding episode file in the newly created folder.

In addition, in the case of a weekly reservation recording, the recording of the corresponding program starts by the reservation recording start unit on the basis of information indicating the same day of the week, the same channel, and the same broadcasting time that are stored beforehand in the memory at the time of reservation. Accordingly, it is possible to start the recording on the same day of the week, at the same channel, and from the same broadcasting time even though the reservation operation is not performed in a weekly basis. For example, one episode per day, that is, seven kinds of episodes per week can be respectively stored in seven folders.

According to the configuration described above, it is possible to realize a function of automatically performing an operation of classifying files corresponding to the same series into the same folder. Accordingly, a user can make a recording reservation with respect to series, which is broadcasted in a daily, weekly, or monthly basis, only by performing an operation of turning on the series distinction function on the electronic program guide and an operation of inputting a number indicating that the series corresponds to which number of the episode in the series. As a result, since time for a file classification work is not necessary, it becomes convenient for a user to use the hard disk recording and playback device. In addition, since the files corresponding to the same series are stored in the same folder, the user can save the time to find a desired file even if many episode files are stored in a hard disk and many days has passed. In addition, since the file arrangement within the hard disk is automatically performed, it is not necessary for the user to perform an operation of arranging files within the hard disk.

According to another aspect of the invention, a hard disk recording and playback device includes a control unit that performs a control such that an electronic program guide is displayed on a display device, the electronic program guide including a date item for displaying a broadcasting date of a television program, a time item for displaying a broadcasting time of the television program, a channel item for displaying a channel of the television program, an episode title item for displaying an episode title, a genre item for displaying a genre of the television program, a series distinction item, an ON/OFF item for turning on/off a series distinction function, and a number information item indicating that each series corresponds to which number of the episode in the series, and that performs a control such that, after a corresponding series is recorded in a state in which the ON of the ON/OFF item displayed on the electronic program guide is selected so as to turn on the series distinction function and number information, which indicates that the corresponding series corresponds to which number of the episode in the series, is input to the number information item, the corresponding series is stored in a folder to which a title of the episode is applied as a name thereof.

In the configuration described above, the electronic program guide is displayed on the display device, the electronic program guide including the date item for displaying the broadcasting date of the television program, the time item for displaying the broadcasting time of the television program, the channel item for displaying the channel of the television program, the episode title item for displaying the episode title, the genre item for displaying the genre of the television program, the series distinction item, the ON/OFF item for turning on/off the series distinction function, and the number information item indicating that each series corresponds to which number of the episode in the series; and that, after the corresponding series is recorded in a state in which the ON of the ON/OFF item displayed on the electronic program guide is selected so as to turn on the series distinction function and the number information, which indicates that the corresponding series corresponds to which number of the episode in the series, is input to the number information item, the corresponding series is stored in the folder to which the title of the episode is applied as the name thereof.

According to the configuration described above, it is possible to realize a function of automatically performing an operation of classifying files corresponding to the same series into the same folder. Accordingly, a user can make a recording reservation with respect to series, which is broadcasted in a daily, weekly, or monthly basis, only by performing an operation of turning on the series distinction function on the electronic program guide and an operation of inputting a number indicating that the series corresponds to which number of the episode in the series. As a result, since time for a file classification work is not necessary, it becomes convenient for a user to use the hard disk recording and playback device. In addition, since the files corresponding to the same series are stored in the same folder, the user can save the time to find a desired file even if many episode files are stored in a hard disk and many days has passed. In addition, since the file arrangement within the hard disk is automatically performed, it is not necessary for the user to perform an operation of arranging files within the hard disk.

In the hard disk recording and playback device, preferably, the control unit includes: an electronic program guide display unit that displays an electronic program guide on a display device, the electronic program guide including a date item for displaying a broadcasting date of a television program, a time item for displaying a broadcasting time of the television program, a channel item for displaying a channel of the television program, an episode title item for displaying an episode title, a genre item for displaying a genre of the television program, a series distinction item, an ON/OFF item for turning on/off a series distinction function, and a number information item indicating that each series corresponds to which number of the episode in the series; a file existence determination unit that determines whether or not a file made by using the series distinction function exists, after a corresponding series is recorded in a state in which the ON of the ON/OFF item displayed on the electronic program guide is selected so as to turn on the series distinction function and number information, which indicates that the corresponding series corresponds to which number of the episode in the series, is input to the number information item or after a corresponding television program is recorded in a state in which the series distinction function is turned off; a genre classification unit that classifies the television program on the basis of a genre when it is determined that the file does not exist; an episode determination unit that determines whether or not the corresponding episode is an episode previously set by using the series distinction function when it is determined that the file exist; a first number information item update unit that updates number information of the number information item, which indicates that the corresponding episode corresponds to which number of the episode in the series, stored in a memory by incrementing the number information of the number information item when it is determined that the corresponding episode is an episode previously set by using the series distinction function; a first folder storage unit that stores a corresponding episode file in a folder to which a title of the episode based on the updated number information, which indicates that the corresponding episode corresponds to which number of the episode in the series, is applied as a name thereof; a second number information item update unit that updates the number information of the number information item, which indicates that the corresponding episode corresponds to which number of the episode in the series, stored in the memory by incrementing the number information of the number information item when the episode determination unit determines that the corresponding episode is not an episode previously set by using the series distinction function; a folder existence determination unit that determines whether or not a folder whose name is the same as the episode title exists after the number information, which indicates that the corresponding episode corresponds to which number of the episode in the series, has been updated by the second number information item update unit; a second folder storage unit that, when it is determined that the folder whose name is the same as the episode title exist, stores the corresponding episode file in the folder whose name is the same as the episode title by adding the number information, which indicates that the episode corresponds to which number of the episode in the series, without creating a new folder; and a third folder storage unit that, when it is determined that the folder whose name is the same as the episode title does not exist, creates a new folder and applies the number information, which indicates that the episode corresponds to which number of the episode in the series, to the new folder so as to store the corresponding episode file in the newly created folder.

As described above, the control unit can perform an electronic program guide display process, a file existence determination process, a genre classification process, an episode determination process, a first number information item update process, a first folder storage process, a second number information item update process, a folder existence determination process, a second folder storage process, and a third folder storage process. As a result, it is possible to realize a function of automatically performing an operation of classifying the files corresponding to the same series into the same folder by means of the control unit.

Further, in the hard disk recording and playback device, preferably, the control unit further includes a reservation recording start unit that, in the case of a weekly reservation recording, starts recording the corresponding program on the basis of information indicating the same day of the week, the same channel, and the same broadcasting time that are stored beforehand in the memory at the time of reservation. Accordingly, it is possible to start the recording on the same day of the week, at the same channel, and from the same broadcasting time even though the reservation operation is not performed in a weekly basis.

As described above, according to the invention, there is provided the control unit having the electronic program guide display unit that displays the electronic program guide on the display device, the electronic program guide including the date item for displaying the broadcasting date of the television program, the time item for displaying the broadcasting time of the television program, the channel item for displaying the channel of the television program, the episode title item for displaying the episode title, the genre item for displaying the genre of the television program, the series distinction item, the ON/OFF item for turning on/off the series distinction function, and the number information item indicating that each series corresponds to which number of the episode in the series; the file existence determination unit that determines whether or not the file made by using the series distinction function exists, after the corresponding series is recorded in the state in which the ON of the ON/OFF item displayed on the electronic program guide is selected so as to turn on the series distinction function and number information, which indicates that the corresponding series corresponds to which number of the episode in the series, is input to the number information item or after the corresponding television program is recorded in the state in which the series distinction function is turned off; the genre classification unit that classifies the television program on the basis of the genre when it is determined that the file does not exist; the episode determination unit that determines whether or not the corresponding episode is the episode previously set by using the series distinction function when it is determined that the file exist; the first number information item update unit that updates number information of the number information item, which indicates that the corresponding episode corresponds to which number of the episode in the series, stored in the memory by incrementing the number information of the number information item when it is determined that the corresponding episode is the episode previously set by using the series distinction function; the first folder storage unit that stores the corresponding episode file in the folder to which the title of the episode based on the updated number information, which indicates that the corresponding episode corresponds to which number of the episode in the series, is applied as the name thereof; the second number information item update unit that updates the number information of the number information item, which indicates that the corresponding episode corresponds to which number of the episode in the series, stored in the memory by incrementing the number information of the number information item when the episode determination unit determines that the corresponding episode is not the episode previously set by using the series distinction function; the folder existence determination unit that determines whether or not the folder whose name is the same as the episode title exists after the number information, which indicates that the corresponding episode corresponds to which number of the episode in the series, has been updated by the second number information item update unit; the second folder storage unit that, when it is determined that the folder whose name is the same as the episode title exist, stores the corresponding episode file in the folder whose name is the same as the episode title by adding the number information, which indicates that the episode corresponds to which number of the episode in the series, without creating the new folder; the third folder storage unit that, when it is determined that the folder whose name is the same as the episode title does not exist, creates the new folder and applies the number information, which indicates that the episode corresponds to which number of the episode in the series, to the new folder so as to store the corresponding episode file in the newly created folder; and the reservation recording start unit that, in the case of a weekly reservation recording, starts recording the corresponding program on the basis of information indicating the same day of the week, the same channel, and the same broadcasting time that are stored beforehand in the memory at the time of reservation. Therefore, it is possible to realize the function of automatically performing the operation of classifying files corresponding to the same series into the same folder, and accordingly, the user can make the recording reservation with respect to series, which is broadcasted in the daily, weekly, or monthly basis, only by performing the operation of turning on the series distinction function on the electronic program guide and the operation of inputting the number indicating that the series corresponds to which number of the episode in the series. As a result, since time for a file classification work is not necessary, it becomes convenient for a user to use the hard disk recording and playback device. In addition, since the files corresponding to the same series are stored in the same folder, the user can save the time to find a desired file even if many episode files are stored in a hard disk and many days has passed. In addition, since the file arrangement within the hard disk is automatically performed, it is not necessary for the user to perform an operation of arranging files within the hard disk.

Furthermore, according to the invention, there is provided the control unit that performs a control such that the electronic program guide is displayed on the display device, the electronic program guide including the date item for displaying the broadcasting date of the television program, the time item for displaying the broadcasting time of the television program, the channel item for displaying the channel of the television program, the episode title item for displaying the episode title, the genre item for displaying the genre of the television program, the series distinction item, the ON/OFF item for turning on/off the series distinction function, and the number information item indicating that each series corresponds to which number of the episode in the series, and that performs a control such that, after the corresponding series is recorded in a state in which the ON of the ON/OFF item displayed on the electronic program guide is selected so as to turn on the series distinction function and number information, which indicates that the corresponding series corresponds to which number of the episode in the series, is input to the number information item, the corresponding series is stored in a folder to which the title of the episode is applied as the name thereof. Therefore, it is possible to realize the function of automatically performing the operation of classifying files corresponding to the same series into the same folder, and accordingly, the user can make the recording reservation with respect to series, which is broadcasted in the daily, weekly, or monthly basis, only by performing the operation of turning on the series distinction function on the electronic program guide and the operation of inputting the number indicating that the series corresponds to which number of the episode in the series. As a result, since time for a file classification work is not necessary, it becomes convenient for a user to use the hard disk recording and playback device. In addition, since the files corresponding to the same series are stored in the same folder, the user can save the time to find a desired file even if many episode files are stored in a hard disk and many days has passed. In addition, since the file arrangement within the hard disk is automatically performed, it is not necessary for the user to perform an operation of arranging files within the hard disk.

### BRIEF DESCRIPTION OF THE DRAWINGS

These and other objects and advantages of this invention will become more fully apparent from the following detailed description taken with the accompanying drawings in which:

FIG. 1 is a block diagram illustrating the configuration of a hard disk recording and playback device according to an embodiment of the invention;

FIG. 2 is a view illustrating an example of a program reservation display screen on an electronic program guide displayed on a display device in the embodiment;

FIG. 3 is a view illustrating the arrangement of main keys of a remote controller in the embodiment; and

FIG. 4 is a flow chart explaining a process of a series distinction function in the embodiment.

### DETAILED DESCRIPTION OF THE EMBODIMENTS

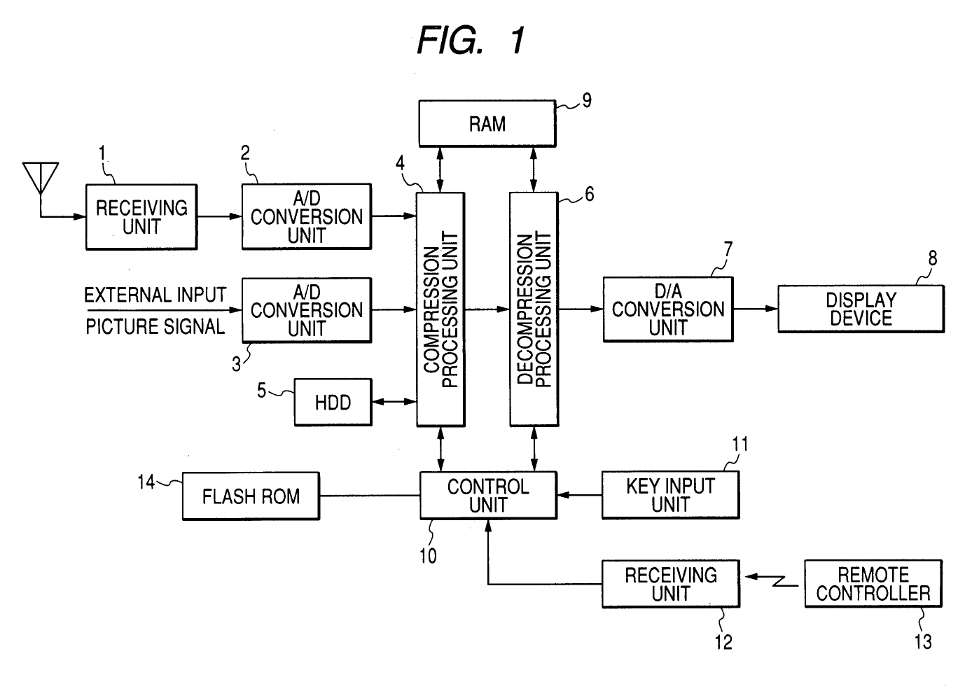

Hereinafter, an embodiment of the invention will be described with reference to the accompanying drawings. FIG. 1 is a block diagram illustrating the configuration of a hard disk recording and playback device according to a first embodiment of the invention.

The hard disk recording and playback device includes a receiving unit 1; an A/D conversion unit 2 that converts an analog picture signal of analog picture and voice signals received from the receiving unit 1 into a digital picture signal; an A/D conversion unit 3 that converts an analog picture signal, which is externally input, into a digital picture signal; a compression processing unit 4 that performs a compression processing on the digital picture signals, which are converted by the A/D conversion units 2 and 3, in MPEG format; an HDD (hard disk drive) 5 that records the compression-processed picture data in a hard disk; and a decompression processing unit 6 that restores the picture data read (reproduced) from the HDD 5 to original picture data.

In addition, the hard disk recording and playback device further includes a D/A conversion unit 7; a display device 8 that displays the picture data, which has been converted into the analog signal by the D/A conversion unit 7, on a screen; a RAM 9 serving as a buffer that temporarily stores the picture data at the time of the compression processing or the decompression processing; a control unit 10 that controls an overall operation of the hard disk recording and playback device; a key input unit 11 that inputs various key operation signals to the control unit 10; a key receiving unit 12 that receives the various key operation signals; a remote controller 13 that performs various key operations; and a flash ROM 14 that stores programs or data necessary for processing of the control unit 10.

The control unit 10 includes an electronic program guide display unit, as a characteristic component of the present embodiment, which displays an electronic program guide on the display device 8. Here, the electronic program guide includes a date item for displaying a broadcasting date of a television program, a time item for displaying a broadcasting time of the television program, a channel item for displaying a channel of the television program, an episode title item for displaying an episode title, a genre item for displaying a genre of the television program, a series distinction item, an ON/OFF item for turning on/off a series distinction function, and a number information item indicating that each series corresponds to which number of the episode in the series.

In addition, the control unit 10 further includes a file existence determination unit that determines whether or not a file made by using the series distinction function exists, after a corresponding series is recorded in a state in which the ON of the ON/OFF item displayed on the electronic program guide is selected so as to turn on the series distinction function and number information, which indicates that the corresponding series corresponds to which number of the episode in the series, is input to the number information item or after a corresponding television program is recorded in a state in which the series distinction function is turned off; a genre classification unit that classifies the television program on the basis of the genre when it is determined that the file does not exist; and an episode determination unit that determines whether or not the corresponding episode is an episode previously set by using the series distinction function when it is determined that the file exist.

In addition, the control unit 10 further includes a first number information item update unit that updates the number information of the number information item, which indicates that the corresponding episode corresponds to which number of the episode in the series, stored in the flash ROM 14 by incrementing the number information of the number information item when it is determined that the corresponding episode is an episode previously set by using the series distinction function; a first folder storage unit that stores the corresponding episode file in a folder to which a title of the episode based on the updated number information, which indicates that the corresponding episode corresponds to which number of the episode in the series, is applied as a name thereof; and a second number information item update unit that updates the number information of the number information item, which indicates that the corresponding episode corresponds to which number of the episode in the series, stored in the flash ROM 14 by incrementing the number information of the number information item when the episode determination unit determines that the corresponding episode is not an episode previously set by using the series distinction function.

In addition, the control unit 10 further includes a folder existence determination unit that determines whether or not a folder whose name is the same as the episode title exists after the number information, which indicates that the series corresponds to which number of the episode in the series, has been updated by the second number information item update unit; a second folder storage unit that, when it is determined that the folder whose name is the same as the episode title exist, stores the corresponding episode file in the folder whose name is the same as the episode title by adding the number information, which indicates that the episode corresponds to which number of the episode in the series, without creating a new folder; and a third folder storage unit that, when it is determined that the folder whose name is the same as the episode title does not exist, creates a new folder and applies the number information, which indicates that the episode corresponds to which number of the episode in the series, to the new folder so as to store the corresponding episode file in the newly created folder.

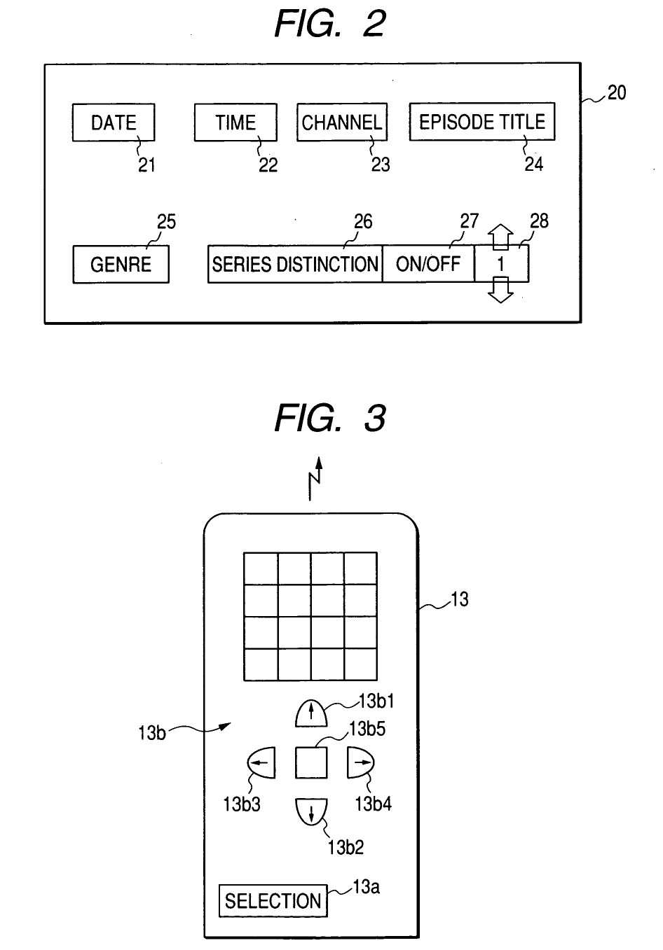

FIG. 2 is a view illustrating an example of a program reservation display screen on an electronic program guide (EPG) displayed on the display device 8 in the present embodiment. On a program reservation display screen 20, a date item 21 for displaying a broadcasting date of a television program, a time item 22 for displaying a broadcasting time, a channel item 23 for displaying a channel, an episode title item 24 for displaying a title of an episode, a genre item 25 for displaying a genre, a series distinction item 26, an ON/OFF item 27 for turning on/off a series distinction function, and a number information item 28 indicating that each series corresponds to which number of the episode in the series.

FIG. 3 is a view illustrating the arrangement of main keys of a remote controller in the present embodiment. As shown in FIG. 3, a remote controller 13 includes a selection key 13a for selecting a reservation menu screen or a playback menu screen and a navigation key 13b for performing various operations on the reservation menu screen or the playback menu screen. The navigation key 13b includes shift keys 13b1, 13b2, 13b3, and 13b4, which are provided to select a job item displayed by shifting a cursor displayed on the screen of the display device 8 up and down and left and right, and a decision key 13b5 which is located at the center of the shift keys 13b1, 13b2, 13b3, and 13b4 and has a function of deciding various selection operations. In addition, the remote controller 13 has various function keys other than those keys described above, which are not shown herein.

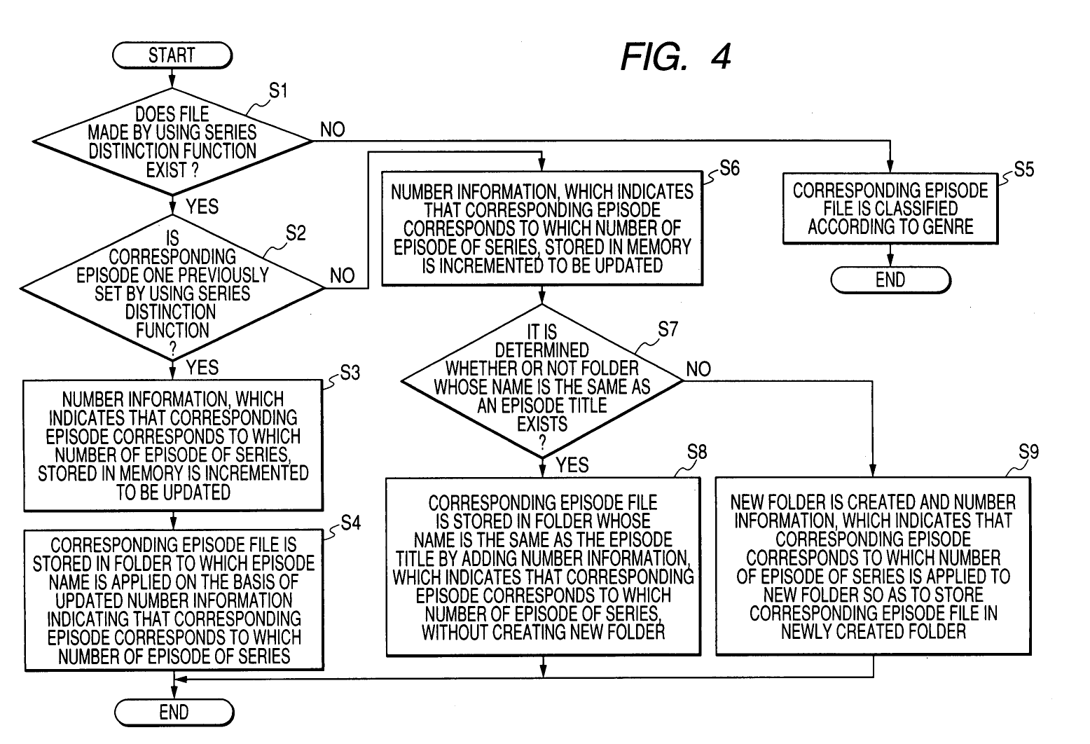

FIG. 4 is a flow chart explaining a process of the series distinction function in the present embodiment. Hereinafter, the series distinction function will be explained with reference to the flow chart and FIGS. 1 to 3.

In order to record a predetermined series, a user displays the program reservation display screen 20, on which a program reservation is made by the EPG (electronic program guide), on the display device 8 by using the electronic program guide display unit of the control unit 10, and then the user can select the ON/OFF of the series distinction function by using the displayed EPG. Subsequently, the user operates the navigation key 13b of the remote controller 13 so as to select the ON of the ON/OFF item 27 on the program reservation display screen 20, and then when the series distinction function is turned on, the user registers the number information, which indicates that the corresponding series corresponds to which number of the episode in the series, on the number information item 28.

As such, after the ON of the ON/OFF item 27 displayed on the program reservation display screen 20 is selected so as to turn on the series distinction function and the number information, which indicates that the corresponding series corresponds to which number of the episode in the series, is input to the number information item 28 and thus a corresponding series is recorded or after a corresponding television program is recorded in a state in which the series distinction function is turned off, the process proceeds to a process shown in the flow chart.

The program (episode) recorded by using the series distinction function is automatically stored in a folder whose name is the same as a title of the program (episode) For example, if the corresponding series program (episode) is episode #1, a name of the recorded file is set as the ‘episode #1’. That is, in the case of the same title, if an initial number, which indicates that the corresponding series program (episode) corresponds to which number of the episode in the series, is input, a file name is automatically created.

First, the file existence determination unit of the control unit 10 determines whether or not a file made by using the series distinction function exists (step S1) If it is determined that the file made by using the series distinction function exists, a file existence flag is set to logic ‘1’, and if it is determined that the file made by using the series distinction function does not exist, the file existence flag is set to logic ‘0’, and accordingly, the determination on the file existence can be made by detecting a value of the file existence flag. Then, if it is determined that the file made by using the series distinction function does not exist, the genre classification unit of the control unit 10 classifies the television program on the basis of a genre (step S5).

On the other hand, if it is determined that the file made by using the series distinction function exists, the episode determination unit of the control unit 10 determines whether or not the corresponding episode is an episode previously set by using the series distinction function (step S2). If it is determined that the corresponding episode is an episode previously set by using the series distinction function, the first number information item update unit 10 updates the number information of the number information item 28, which indicates that the corresponding episode corresponds to which number of the episode in the series, stored in the flash ROM 14 by incrementing the number information of the number information item (step S3). Then, the first folder storage unit of the control unit 10 stores the corresponding episode file in a folder to which a title of the episode based on the updated number information, which indicates that the corresponding episode corresponds to which number of the episode in the series, is applied as a name thereof (step S4).

On the other hand, in step S2, if it is determined that the corresponding episode is not an episode previously set by using the series distinction function, the second number information item update unit of the control unit 10 updates the number information of the number information item, which indicates that the corresponding episode corresponds to which number of the episode in the series, stored in the flash ROM 14 by incrementing the number information of the number information item (step S6). After the second number information item update unit has updated the number information indicating that the corresponding episode corresponds to which number of the episode in the series, the folder existence determination unit of the control unit 10 determines whether or not a folder whose name is the same as an episode title exists (step S7).

If it is determined that the folder whose name is the same as the episode title exist, the second folder storage unit of the control unit 10 stores the corresponding episode file in the folder whose name is the same as the episode title by adding the number information, which indicates that the episode corresponds to which number of the episode in the series, without creating a new folder (step S8). On the other hand, if it is determined that the folder whose name is the same as the episode title does not exist, a new folder is created and the number information, which indicates that the episode corresponds to which number of the episode in the series is applied to the new folder so as to store the corresponding episode file in the newly created folder (step S9).

In addition, in the case of a weekly reservation recording, a reservation recording start unit of the control unit 10 starts recording the corresponding program on the basis of information indicating the same day of the week, the same channel, and the same broadcasting time that are stored beforehand in the flash ROM 14 at the time of reservation. Thus, it is possible to start the recording on the same day of the week, at the same channel, and from the same broadcasting time even though the reservation operation is not performed in a weekly basis. For example, one episode per day, that is, seven kinds of episodes per week can be respectively stored in seven folders.

As described above, according to the present embodiment, it is possible to realize a function of automatically performing an operation of classifying files corresponding to the same series into the same folder. Accordingly, a user can make a recording reservation with respect to series, which is broadcasted in a daily, weekly, or monthly basis, only by performing an operation of turning on the series distinction function on the electronic program guide and an operation of inputting a number indicating that the series corresponds to which number of the episode in the series. As a result, since time for a file classification work is not necessary, it becomes convenient for a user to use the hard disk recording and playback device. In addition, since the files corresponding to the same series are stored in the same folder, the user can save the time to find a desired file even if many episode files are stored in a hard disk and many days has passed. In addition, since the file arrangement within the hard disk is automatically performed, it is not necessary for the user to perform an operation of arranging files within the hard disk.

What is claimed is:

1. A hard disk recording and playback device that performs a recording/playback of information with respect to a hard disk, comprising:
a control unit,
wherein the control unit includes:
an electronic program guide display unit that displays an electronic program guide on a display device, the electronic program guide including a date item for displaying a broadcasting date of a television program, a time item for displaying a broadcasting time of the television program, a channel item for displaying a channel of the television program, an episode title item for displaying an episode title, a genre item for displaying a genre of the television program, a series distinction item, an ON/OFF item for turning on/off a series distinction function, and a number information item indicating that each series corresponds to which number of the episode in the series;
a file existence determination unit that determines whether or not a file made by using the series distinction function exists, after a corresponding series is recorded in a state in which the ON of the ON/OFF item displayed on the electronic program guide is selected so as to turn on the series distinction function and number information, which indicates that the corresponding series corresponds to which number of the episode in the series, is input to the number information item or after a corresponding television program is recorded in a state in which the series distinction function is turned off;
a genre classification unit that classifies the television program on the basis of a genre when it is determined that the file does not exist;
an episode determination unit that determines whether or not the corresponding episode is an episode previously set by using the series distinction function when it is determined that the file exist;
a first number information item update unit that updates number information of the number information item, which indicates that the corresponding episode corresponds to which number of the episode in the series, stored in a memory by incrementing the number information of the number information item when it is determined that the corresponding episode is an episode previously set by using the series distinction function;
a first folder storage unit that stores a corresponding episode file in a folder to which a title of the episode based on the updated number information, which indicates that the corresponding episode corresponds to which number of the episode in the series, is applied as a name thereof;
a second number information item update unit that updates the number information of the number information item, which indicates that the corresponding episode corresponds to which number of the episode in the series, stored in the memory by incrementing the number information of the number information item when the episode determination unit determines that the corresponding episode is not an episode previously set by using the series distinction function;
a folder existence determination unit that determines whether or not a folder whose name is the same as the episode title exists after the number information, which indicates that the corresponding episode corresponds to which number of the episode in the series, has been updated by the second number information item update unit;
a second folder storage unit that, when it is determined that the folder whose name is the same as the episode title exist, stores the corresponding episode file in the folder whose name is the same as the episode title by adding the number information, which indicates that the episode corresponds to which number of the episode in the series, without creating a new folder;
a third folder storage unit that, when it is determined that the folder whose name is the same as the episode title does not exist, creates a new folder and applies the number information, which indicates that the episode corresponds to which number of the episode in the series, to the new folder so as to store the corresponding episode file in the newly created folder; and
a reservation recording start unit that, in the case of a weekly reservation recording, starts recording the corresponding program on the basis of information indicating the same day of the week, the same channel, and the same broadcasting time that are stored beforehand in the memory at the time of reservation.

2. A hard disk recording and playback device that performs a recording/playback of information with respect to a hard disk, comprising:
a control unit that performs a control such that an electronic program guide is displayed on a display device, the electronic program guide including a date item for displaying a broadcasting date of a television program, a time item for displaying a broadcasting time of the television program, a channel item for displaying a channel of the television program, an episode title item for displaying an episode title, a genre item for displaying a genre of the television program, a series distinction item, an ON/OFF item for turning on/off a series distinction function, and a number information item indicating that each series corresponds to which number of the episode in the series, and that performs a control such that, after a corresponding series is recorded in a state in which the ON of the ON/OFF item displayed on the electronic program guide is selected so as to turn on the series distinction function and number information, which indicates that the corresponding series corresponds to which number of the episode in the series, is input to the number information item, the corresponding series is stored in a folder to which a title of the episode is applied as a name thereof.

3. The hard disk recording and playback device according to claim 2,
wherein the control unit includes:
an electronic program guide display unit that displays an electronic program guide on a display device, the electronic program guide including a date item for displaying a broadcasting date of a television program, a time item for displaying a broadcasting time of the television program, a channel item for displaying a channel of the television program, an episode title item for displaying an episode title, a genre item for displaying a genre of the television program, a series distinction item, an ON/OFF item for turning on/off a series distinction function, and a number information item indicating that each series corresponds to which number of the episode in the series;
a file existence determination unit that determines whether or not a file made by using the series distinction function exists, after a corresponding series is recorded in a state in which the ON of the ON/OFF item displayed on the electronic program guide is selected so as to turn on the series distinction function and number information, which indicates that the corresponding series corresponds to which number of the episode in the series, is input to the number information item or after a corresponding television program is recorded in a state in which the series distinction function is turned off;
a genre classification unit that classifies the television program on the basis of a genre when it is determined that the file does not exist;
an episode determination unit that determines whether or not the corresponding episode is an episode previously set by using the series distinction function when it is determined that the file exist;
a first number information item update unit that updates number information of the number information item, which indicates that the corresponding episode corresponds to which number of the episode in the series, stored in a memory by incrementing the number information of the number information item when it is determined that the corresponding episode is an episode previously set by using the series distinction function;
a first folder storage unit that stores a corresponding episode file in a folder to which a title of the episode based on the updated number information, which indicates that the corresponding episode corresponds to which number of the episode in the series, is applied as a name thereof;
a second number information item update unit that updates the number information of the number information item, which indicates that the corresponding episode corresponds to which number of the episode in the series, stored in the memory by incrementing the number information of the number information item when the episode determination unit determines that the corresponding episode is not an episode previously set by using the series distinction function;
a folder existence determination unit that determines whether or not a folder whose name is the same as the episode title exists after the number information, which indicates that the corresponding episode corresponds to which number of the episode in the series, has been updated by the second number information item update unit;
a second folder storage unit that, when it is determined that the folder whose name is the same as the episode title exist, stores the corresponding episode file in the folder whose name is the same as the episode title by adding the number information, which indicates that the episode corresponds to which number of the episode in the series, without creating a new folder; and
a third folder storage unit that, when it is determined that the folder whose name is the same as the episode title does not exist, creates a new folder and applies the number information, which indicates that the episode corresponds to which number of the episode in the series, to the new folder so as to store the corresponding episode file in the newly created folder.

4. The hard disk recording and playback device according to claim 2,
wherein the control unit further includes a reservation recording start unit that, in the case of a weekly reservation recording, starts recording the corresponding program on the basis of information indicating the same day of the week, the same channel, and the same broadcasting time that are stored beforehand in the memory at the time of reservation.
